(19) United States
(12) Patent Application Publication
(10) Pub. No.: US 2018/0031201 A1
(43) Pub. Date: Feb. 1, 2018

(54) Illumination Device for a Vehicle, an Illumination Arrangement Comprising Two Illumination Devices, and a Method for Operating Said Illumination Arrangement

(71) Applicant: Robert Bosch GmbH, Stuttgart (DE)

(72) Inventors: Mihel Seitz, Eningen Unter Achalm (DE); Andreas Petersen, Marbach (DE)

(21) Appl. No.: 15/524,188

(22) PCT Filed: Sep. 29, 2015
(86) PCT No.: PCT/EP2015/072327

§ 371 Date: May 3, 2017

(30) Foreign Application Priority Data
Dec. 2, 2014 (DE) 10 2014 224 572.9

(51) Int. Cl. F21S 8/10

(52) U.S. Cl. CPC F21S 48/1757; F21S 48/1145; F21S 48/1388; F21S 48/14

(57) ABSTRACT

In one embodiment, an illumination device for a vehicle includes a light source operable for generating a light beam and a beam deflection unit operable for deflecting the light beam. The illumination device also includes a luminous layer element operable to be selectively illuminatable with the light beam in its planar extent using the beam deflection unit. The illumination device also includes a reflector element arranged in a manner adjoining the luminous layer element. The reflector element is configured such that the luminous layer element and the reflector element are illuminatable by the deflected light beam. The light beam impinging on the reflector element is divertable onto the luminous layer element.

The present invention relates to an illumination device for a vehicle comprising a light source for generating a light beam and comprising a beam deflection unit for deflecting the light beam, wherein a luminous layer element is provided, which is selectively illuminatable with the light beam in its planar extent by means of the beam deflection unit, and wherein light for projection in front of the vehicle is generatable by the illumination of the luminous layer element. Vehicle here is understood to mean motor vehicle, truck, motorcycle, e-bike, scooter, etc.

### PRIOR ART

DE 10 2010 028 949 A1 discloses an illumination device for a vehicle comprising a light source formed as a laser beam source, and the laser beam source emits a laser beam having for example a blue wavelength. Via a beam deflection unit comprising a mirror as an essential and optically active component, the laser beam can be moved over a luminous layer element by means of a scanner movement of the mirror. In this case, the laser beam excites a converter layer of the luminous layer element, as a result of which white light is emitted again via the converter layer. As a result, the illumination device generates in general white light which can serve for fulfilling a main light function of the illumination device, that is to say for example the high beam or the low beam of a headlight for a vehicle.

In this case, the electromagnetic radiation emitted by the light source, that is to say for example a blue laser beam, can be selectively scanned by means of the beam deflection unit over substantially the entire extent of the luminous layer element, and with a resonantly oscillating mirror of the beam deflection unit in a main deflection direction, the generated focal spot can be moved over the converter layer of the luminous layer element so rapidly that the movement of the focal spot of the laser beam on the converter layer is no longer perceptible to the human eye. Rather, the scanner movement on the luminous layer element, by way of the converted and white emissive light, appears as a line emitter or an area emitter, depending on whether the laser beam is deflected in only a main direction or else for example in a secondary direction formed perpendicularly thereto and is guided over the luminous layer element. Disposed downstream of the luminous layer element there may also be a beam shaping optical unit, for example a projection optical unit, by means of which the illumination field generated on the luminous layer element is projected in front of a vehicle in order for example to generate a low-beam light distribution or a high-beam light distribution.

In order to achieve a dynamic adaptation of the light distribution on the luminous layer element, provision is made for controlling the laser radiation used for exciting the converter layer with the aid of a drivable beam deflection unit. However, the beam deflection unit comprising a resonantly oscillating mirror has the disadvantage that the speed of the generated focal spot on the luminous layer element marginally, that is to say in the region of the reversal of the mirror movement, slows down the speed or the latter is reduced to zero, and only afterward is the mirror accelerated again in its rotation oscillation. Upon passing through the central position, the mirror is at its highest speed here, which leads to a particularly low intensity of the emitted white light.

In contrast to the deflection of a massless electron beam, for example, a mirror, on account of its mass inertia, cannot be arbitrarily driven and moved dynamically. In particular, the line frequencies in the range of a few kilohertz that are necessary for a high resolution and freedom from flicker of an illumination device of the design of interest here can be realized only with a mirror moved resonantly in at least one spatial direction, usually horizontally. In the case of such a harmonic oscillator that is formed by the movable mirror, the physically determined temporal profile of the angular excursion of the mirror around a zero position has the effect that the residence probability of the mirror in the reversal regions, that is to say in other words in the region of the respective maximum excursion away from the zero position, is maximal. Consequently, this results in a particularly high intensity marginally, and in the center, i.e. around the zero position, a particularly low intensity, which should be avoided for a typical illumination device of a headlight of a vehicle.

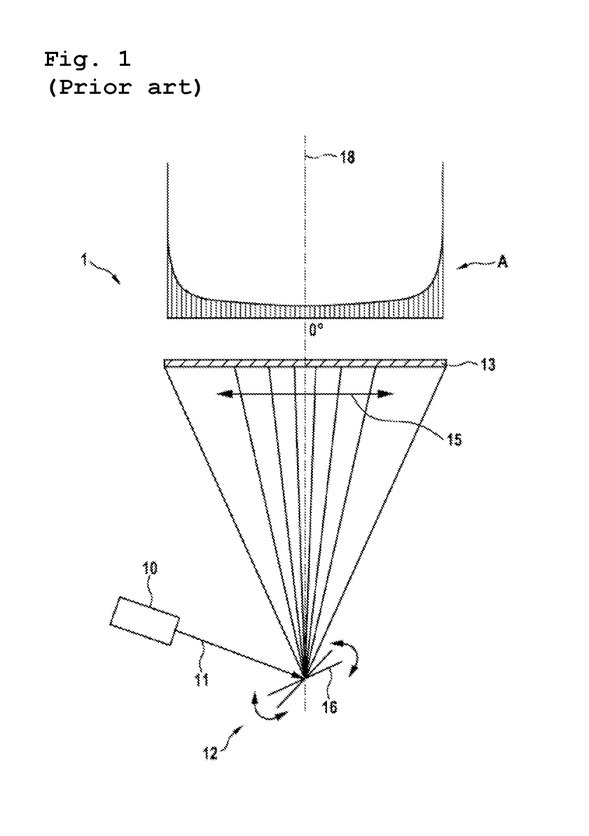

In the case of a permanently switched-on and thus efficiently utilized laser beam source as light source for an illumination device, the light distribution A in accordance with FIG. 1 would also correspond to the light distribution on the luminous layer element. The light intensity would thus be highest at the edges of the illuminated region since the reversal print of the mirror lies here and the mirror speed is momentarily equal to zero in this case. In the center, by contrast, shown with 0°, the residence probability is lowest since the mirror speed is maximal here.

In this respect, FIG. 1 shows the prior art in a schematic depiction, showing an illumination device 1 comprising a light source 10, which directs a light beam 11 onto a beam deflection unit 12 comprising a mirror 16, for example a laser beam. The mirror 16 is set in oscillating motion by the beam deflection unit 12, as shown by the arrows, such that the light beam 11 is deflected in a main deflection direction 15. The deflected light beam 11 impinges on the rear side of the luminous layer element 13, which, on the front side, generates the shown light distribution A with white light, and the generated white light can be projected in front of a vehicle by a corresponding optical system. In this case, the light intensity is highest marginally, such that the intensity rises further and further at the greatest distance from the center axis 18, which may form the optical axis of the light field, for example.

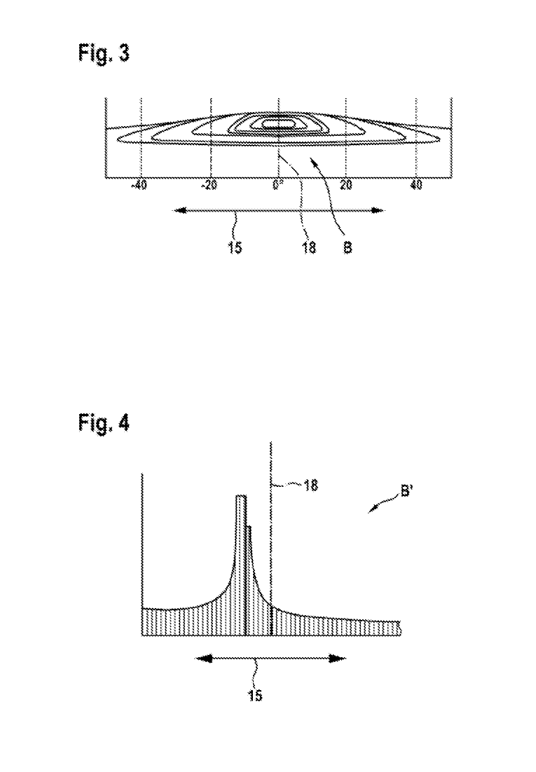

Such a light distribution, as shown in FIG. 1 with the light distribution A, precisely does not correspond to a typical light distribution of a headlight, such as is shown in FIG. 3. An intensity maximum of this desired light distribution B lies near the center axis 18, indicated by an angle of 0°. The angle is scaled negatively to the left of the 0° axis; the angle is scaled positively to the right of the 0° axis. It would therefore be desirable to generate a light distribution such as is shown in FIG. 3 using the basic construction of an illumination device as shown in FIG. 1.

### DISCLOSURE OF THE INVENTION

It is an object of the invention to improve an illumination device of the design presented above, and the illumination device is intended to generate a light distribution such as at least in part substantially corresponds to a light distribution for illuminating the area in front of a vehicle. In this case, the light source is intended to be utilized as efficiently as possible.

This object is achieved on the basis of an illumination device according to the preamble of claim 1, on the basis of an illumination arrangement comprising two illumination devices according to claim 7 and on the basis of a method according to claim 8 with the respective characterizing features. Advantageous developments of the invention are specified in the dependent claims.

The invention includes the technical teaching that a reflector element is provided, which is arranged in a manner adjoining the luminous layer element, wherein the reflector element is configured such that the luminous layer element and the reflector element are illuminatable by the deflected light beam, and that the light beam impinging on the reflector element is divertable onto the luminous layer element.

The invention advantageously utilizes the possibility of folding the light beam that scans in a main deflection direction such that the luminous layer element is directly illuminated by the scanned light beam and at the same time the luminous layer element is indirectly illuminated via the reflector element. The moved light beam impinging on the reflector element with a temporal portion is thus brought to a superimposition with the light beam impinging directly on the luminous layer element by means of the reflector element. This folding of the light beam makes it possible to form only one marginal region with an increased intensity, while a transition between the luminous layer element and the reflector element forms a marginal region of the generatable light field in which the mirror speed and thus the speed of the focal spot on the luminous layer element are maximal. Consequently, as described in the introduction, this marginal region with the minimum intensity can be correspondingly utilized to form a customary light field for illuminating the area in front of a vehicle. In this case, the light source, for example embodied as a laser beam source, does not have to be modulated and can be operated with full power in continuous-wave operation, wherein the power provided can be utilized by the light source fully for the generation of the light field by the illumination device.

By way of example, the light beam is deflectable by the beam deflection unit in at least one main deflection direction over a scanner angle, wherein the luminous layer element and the reflector element are arranged alongside one another in the main deflection direction. In this case, the light beam can additionally be deflected in a secondary direction, which is perpendicular to the main deflection direction, for example by means of a second mirror of the beam deflection unit. In this case, the main deflection direction may correspond to a transverse direction of a vehicle in or on which the illumination device is set up.

The luminous layer element and the reflector element are advantageously formed with a mutually identical width in the main deflection direction, such that the transition between the luminous layer element and the reflector element lies in the angle bisector of the scanner angle. What is achieved as a result is that the movement of the mirror of the beam deflection unit is maximal at the transition, and so the movement of the focal spot on the luminous layer element is also maximal in the region of the transition to the reflector element. The adjoining region of the transition can form, via the luminous layer element, a region of a light field which is projected via a projection optical unit as area in front of a vehicle, which likewise corresponds to a marginal region. By contrast, the marginal region of the luminous layer element in the main deflection direction, which marginal region is embodied opposite the reflector element, can be assigned to the center of a light field, at which the highest intensity is desired.

Particularly advantageously, the reflector element can be formed as a freeform reflector, in particular in such a way that the light reflected from the reflector element onto the luminous layer element has an intensity distribution which is congruent with the intensity distribution of the directed illumination of the luminous layer element, that is to say for example with the laser beam. As a result, the luminous layer element is illuminated with a doubled intensity, as a result of which even the light source can be designed to be weaker. The light source can be formed by a laser beam source and the luminous layer element can have a converter layer which converts the impinging laser radiation of a first wavelength into emissive light of at least one second wavelength. The converted light of the second wavelength can be white light, for example, wherein the laser beam can have a blue wavelength, for example. In this case, the blue wavelength can likewise also form a color portion for generating the white light. Usually, as a result an additive color mixing is generated, and the converter layer, for example a phosphor layer, can be designed such that white light arises for example as a result of the color mixing of blue, green and red light, which white light can be utilized for customary illumination of the area in front of a vehicle. In particular, it is possible to adapt the wave spectrum for providing the light distribution in front of the vehicle with a color temperature such that optimum mesopic or scotopic vision of a driver of a vehicle is made possible.

The invention is furthermore directed to an illumination arrangement for a vehicle comprising a left illumination device and comprising a right illumination device, such that the illumination arrangement comprises two illumination devices, which are embodied as described above. In this case, the luminous layer elements in the illumination devices can be arranged in a manner facing toward one another, wherein the reflector elements in the illumination devices are arranged on the outer side. Thus, during simultaneous operation of both illumination devices, illumination of the area in front of the vehicle is generated such as corresponds to a typical low-beam light distribution, as described in the introduction.

Furthermore, the invention is directed to a method for operating an illumination arrangement of the above-described embodiment comprising two illumination devices, wherein oscillation amplitudes of the mirrors in the illumination devices can be varied in a manner coordinated with one another. In this case, the beam deflection units are driven in a correspondingly modulated manner, and, by way of example, a beam deflection unit of a first illumination device can be driven in a manner deviating from the manner in which the beam deflection unit of the second illumination device is driven.

The method furthermore provides for the oscillation amplitudes of the mirrors of the beam deflection units to be varied depending on a cornering travel of the vehicle. With the variation of the oscillation amplitudes of the mirrors, it is also possible to vary the power of the light sources with the illumination devices jointly or with respect to one another. The different driving of the beam deflection units thus enables a cornering light function to be fulfilled.

In accordance with one variant, the division between the extent of the luminous layer element in the main deflection direction and the reflector element can also be provided in an unequally distributed manner; by way of example, the width of the luminous layer element in the main deflection direction need not be equal to the width of the reflector element, such that the light distribution can also be adapted further by means of a corresponding geometrical modification. If two illumination devices are used for an illumination arrangement, the light distributions of both illumination devices can also turn out to be different. By way of example, the light distributions can also overlap. In particular, provision can be made of a plurality of mirrors and a plurality of luminous layer elements for forming a single illumination device, wherein individual luminous layer elements can form for example in each case a part of a light field which is generated for fulfilling a light function in front of a vehicle. If a plurality of mirrors are used per illumination device, then the amplitudes thereof can also be varied within an illumination device in order to vary the light distribution. Furthermore, both oscillation axes of two mirrors can also be operated resonantly. In the beam path between the mirrors and the luminous layer element, even further optical elements for the correction of possible distortions can be introduced in addition to the reflector element. By means of a temporal modulation of the light source, for example of a laser beam source, that is synchronized with the excursion of the mirror, parts of the light distribution can be “blanked” in a targeted manner. In this way, by way of example, it is possible to avoid dazzling other road users, and a dazzle-free high beam can be provided.

The illumination device described above can furthermore be utilized, for example, to project image data onto the roadway or other surfaces in the surroundings, wherein, in a simple manner, the light beam has to be directed onto corresponding regions of the luminous layer element which generate a corresponding intensity distribution on the luminous layer elements. This intensity distribution is finally projected via a projecting optical unit as area in front of the vehicle.

### PREFERRED EXEMPLARY EMBODIMENT OF THE INVENTION

Further measures that improve the invention are illustrated in greater detail below together with the description of one preferred exemplary embodiment of the invention with reference to the figures, in which:

FIG. 1 shows a schematic view of an illumination device in accordance with the prior art with a light distribution that is characteristic of the construction shown,

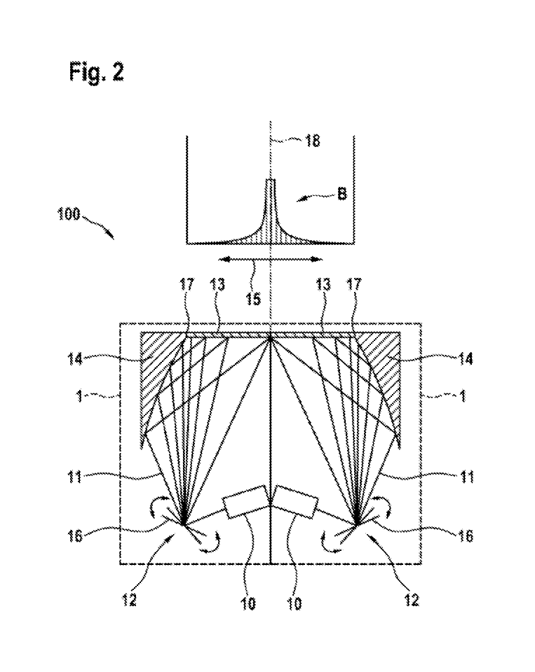

FIG. 2 shows a schematic illustration of two illumination devices for forming an illumination arrangement according to the invention with a resulting light distribution,

FIG. 3 shows a light distribution for generating illumination in the front area in accordance with the prior art, in particular a high-beam light distribution, generatable by means of an illumination arrangement in accordance with FIG. 2,

FIG. 4 shows an intensity distribution against a main deflection direction, said intensity distribution having a maximum to the left of a center axis, and

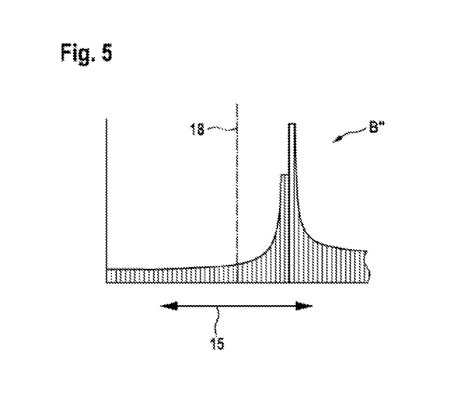

FIG. 5 shows the intensity distribution in accordance with FIG. 4, wherein the intensity maximum prevails to the right of the center axis.

FIG. 1 has already been described together with the characteristic light distribution shown in the introductory part of the present description.

FIG. 2 shows a construction according to the invention of an illumination arrangement 100 comprising two illumination devices 1, and the illumination devices 1 can form individual light modules in a headlight of a vehicle, such that two illumination devices 1 can be provided in a headlight or the illumination devices 1 form the headlights of a vehicle themselves and are correspondingly arranged in a manner spaced apart from one another. During the operation of both illumination devices 1, it is possible to generate a light distribution B around a center axis 18 in a main deflection direction 15, as described in greater detail below.

The illumination devices 1 each comprise a light source 10, which serves for generating a light beam 11, and a beam deflection unit 12 comprising a mirror 16 is provided, said mirror being set in oscillatory motion resonantly in a spatial axis. The light beam 11 impinges on the mirror 16 of the beam deflection unit 12 and is deflected in a main deflection direction 15 by resonant rotary-oscillatory motion of the mirrors 16. If the light source 10 is operated, then a luminous layer element 13 is illuminated by the deflected light beam 11, wherein the illumination can be effected on the rear side, for example, and, on the side facing away from the light irradiation by the light beam 11, the luminous layer element 13 can generate the light distribution designated by B and correspondingly emit the light. In a manner not shown in more specific detail, the luminous layer element 13 has a converter layer, for example a phosphor layer, and the light source 10 can be a laser beam source. The provided light of the laser beam source can comprise a blue wavelength, for example, wherein the light distribution B with white light is finally generated by the converter layer in the luminous layer element 13.

Reflector elements 14 are arranged marginally in a manner adjoining the luminous layer elements 13 of the two illumination devices 1, said reflector elements having a reflector side embodied as a freeform reflector. In this case, the beam deflection unit 12 is configured such that the luminous layer element 13 and the reflector element 14 are irradiated by the respective light beam 11 in the same way and, in particular, with an approximately identical duration, in particular by the motion of the mirrors 16 being implemented accordingly. The light impinging on the reflector element 14 is deflected in the direction toward the respective luminous layer element and is absorbed by the latter. As a result, the principle of a folded light beam arises, and the freeform reflector of the reflector element 14 can be embodied such that the luminous layer element 13 is illuminated via the light reflected by the reflector element 14 with the same intensity distribution as also the directed illumination with the light beam 11 via the mirror 16.

The arrangement of the two illumination devices 1 in a manner adjoining one another as shown makes it possible to form an illumination arrangement 100 which leads to the desired light distribution B. Said light distribution has a maximum in the center axis 18, and the intensity of the light distribution decreases further and further in the marginal regions, and a minimum is generated at the transitions 17 between the luminous layer element 13 and the reflector element 14. Said transitions 17 form the center region of the main deflection direction 15, in which the speed of movement of the mirrors 16 of the beam deflection unit 12 has a maximum. Consequently, as a result of the very high speed of the focal spot there, generated by the light beam 11 on the luminous layer element 13, the intensity becomes minimal at the transitions 17.

FIGS. 4 and 5 show a variant of the light distribution B in accordance with FIG. 2, and FIG. 4 shows the light distribution B′ with a maximum on the side to the left of the center axis 18, and FIG. 5 shows the light distribution B″ on the side to the right of the center axis 18. These light distributions enable a cornering light function of the illumination arrangement 100 in accordance with FIG. 2, and the intensity maxima lying off-center can be achieved by means of a corresponding driving of the beam deflection units 12.

By virtue of the above-described maxima of the intensity distributions, adaptive cornering light functions can be fulfilled, and the intensity maximum can be led out from the center axis 18 by the oscillation amplitudes of the resonantly oscillating mirrors 16 of the two illumination devices 1 being embodied differently with respect to one another by means of a corresponding driving. The beam deflection units 12 can be connected to a drive unit which increases the oscillation amplitude of one mirror 16, while the oscillation amplitude of the other mirror is reduced. One possible implementation of such a driving can be achieved by the fact that the light distributions in the case of oscillation amplitudes of, for example, 70% of the maximum value respectively allowed for the mirrors 16 directly adjoin one another or slightly overlap. If, by way of example, the amplitude of the left mirror 16 is then reduced to 55% and at the same time the amplitude of the right mirror 16 is increased to 85%, the intensity maximum is shifted toward the left, as shown by way of example in FIG. 4. The intensity maximum can be analogously shifted toward the right if, for example, the amplitude of the mirror in the left headlight is increased to 85% and the amplitude of the left mirror 16 is reduced to 55%.

The embodiment of the invention is not restricted to the preferred exemplary embodiment specified above. Rather, a number of variants are conceivable which make use of the illustrated solution in fundamentally different types of embodiments as well. All features and/or advantages, including structural details, spatial arrangement and method steps, as are evident from the claims, the description or the drawings may be essential to the invention both by themselves and in a wide variety of combinations.

1. An illumination device for a vehicle comprising:
a light source operable for generating a light beam;
a beam deflection unit operable for deflecting the light beam;
a luminous layer element operable to be selectively illuminatable with the light beam in its planar extent using the beam deflection unit; and
a reflector element arranged in a manner adjoining the luminous layer element;
wherein light for projection in front of the vehicle is generatable by the illumination of the luminous layer element,
wherein
the reflector element is configured such that the luminous layer element and the reflector element are illuminatable by the deflected light beam, and
wherein the light beam impinging on the reflector element is divertable onto the luminous layer element.

2. The illumination device as claimed in claim 1, wherein the light beam is deflectable by the beam deflection unit in at least one main deflection direction over a scanner angle, and
wherein the luminous layer element and the reflector element are arranged alongside one another in the main deflection direction.

3. The illumination device as claimed in claim 2, wherein the luminous layer element and the reflector element are formed with a mutually identical angle width in the main deflection direction, such that transition between the luminous layer element and the reflector element lies in an angle bisector of the scanner angle.

4. The illumination device as claimed in claim 1, wherein the reflector element is formed as a freeform reflector.

5. The illumination device as claimed in claim 1, wherein at least one of (i) the light source is formed by a laser beam source or (ii) the luminous layer element has a converter layer which converts an impinging laser radiation of a first wavelength into emissive light of at least one second wavelength.

6. The illumination device as claimed in claim 1, wherein the beam deflection unit has at least one mirror operable to be caused to oscillate with an oscillation amplitude.

7. An illumination arrangement for a vehicle comprising:
a left illumination device; and
a right illumination device,
wherein the left illumination device and the right illumination device each include:
a light source operable for generating a light beam;
a beam deflection unit operable for deflecting the light beam;
a luminous layer element operable to be selectively illuminatable with the light beam in its planar extent using the beam deflection unit; and
a reflector element arranged in a manner adjoining the luminous layer element,
wherein light for projection in front of the vehicle is generatable by the illumination of the luminous layer element,
wherein the reflector element is configured such that the luminous layer element and the reflector element are illuminatable by the deflected light beam,
wherein the light beam impinging on the reflector element is divertable onto the luminous layer element,
wherein the luminous layer elements in the left and the right illumination devices are arranged in a manner facing toward one another, and
wherein the reflector elements in the left and the right illumination devices are arranged on the outer side.

8. A method for operating an illumination arrangement comprising:
varying oscillation amplitudes of mirrors in a left and a right illumination device in a manner coordinated with one another,
wherein the left illumination device and the right illumination device of a vehicle each include:
a light source operable for generating a light beam;
a beam deflection unit operable for deflecting the light beam;
a luminous layer element operable to be selectively illuminatable with the light beam in its planar extent using the beam deflection unit; and
a reflector element arranged in a manner adjoining the luminous layer element,
wherein light for projection in front of the vehicle is generatable by the illumination of the luminous layer element,
wherein the reflector element is configured such that the luminous layer element and the reflector element are illuminatable by the deflected light beam,
wherein the light beam impinging on the reflector element is divertable onto the luminous layer element,
wherein the luminous layer elements in the illumination devices are arranged in a manner facing toward one another, and
wherein the reflector elements in the illumination devices are arranged on the outer side.

9. The method as claimed in claim 8, further comprising:
varying the oscillation amplitudes of the mirrors depending on a cornering travel of the vehicle.

10. The method as claimed in claim 8, further comprising:
varying powers of light sources in the left and right illumination devices with the variation of the oscillation amplitudes of the mirrors jointly or with respect to one another.

11. The illumination device as claimed in claim 4, wherein the reflector element is formed as a freeform reflector in such a way that light reflected from the reflector element onto the luminous layer element is configured with a light distribution of the direct illumination of the luminous layer element.
